(19) United States
(12) Patent Application Publication
(10) Pub. No.: US 2014/0149174 A1
(43) Pub. Date: May 29, 2014

(54) Financial Risk Analytics for Service Contracts

(71) Applicant: INTERNATIONAL BUSINESS MACHINES CORPORATION, Armonk, NY (US)

(72) Inventors: Geraldine L. Abbott, Lutherville, MD (US); Sherif A. Goma, Yorktown Heights, NY (US); Allen D. Grussing, Yorktown Height, NY (US); Richard D. Howard, Enterprise, AL (US); Sinem Guven Kaya, Yorktown Heights, NY (US); Peter Lorenzen, Boulder, CO (US); Sergey Makogon, Sandy, UT (US); Satya Nitta, Yorktown Heights, NY (US); Anatoli Olkhovets, Yorktown Heights, NY (US); Natalia M. Ruderman, Yorktown Heights, NY (US); Shu Tao, Yorktown Heights, NY (US)

(73) Assignee: INTERNATIONAL BUSINESS MACHINES CORPORATION, Armonk, NY (US)

(21) Appl. No.: 13/685,362

(22) Filed: Nov. 26, 2012

(51) Int. Cl. G06Q 10/06

(52) U.S. Cl. CPC G06Q 10/0635
USPC 705/7.28

(57) ABSTRACT

A method for predicting and quantifying risk in information technology (IT) service contracts includes comparing features of a new IT service contract with similar features from one or more previous IT service contracts selected from a plurality of previous IT service contracts to calculate a similarity value between each pair of the new IT service contract and one of the one or more previous IT service contracts, aggregating the similarity values, and using the aggregated similarity values with a prediction model to predict risk factors affecting the new IT service contract and to quantify an impact of each predicted risk factor on an expected gross profit margin.

### BACKGROUND

1. Technical Field

The present disclosure is directed to systems and method for predicting and quantifying contract risk for information technology (IT) service contracts.

2. Discussion of Related Art

Information technology (IT) service contracts allows clients to contract the operation of IT systems and processes to a specialized service provider, so the clients can focus on their core business functions. As such, service providers strive to provide uninterrupted, high quality delivery of service to achieve high levels of client satisfaction, while at the same time maintaining continuous contract profitability.

In practice, a significant number of new service contracts financially underperform when compared to the original budget and plan. This is because service providers often need to make a decision about whether to undertake a contract without having proper access to the client's IT environment to understand potential risks. During an engagement phase prior to contract signing, clients are often reluctant to reveal critical or precise information about their IT operations as there is no guarantee that the service provider they are negotiating with would eventually be the one who takes over their operations.

Contract risk prediction and quantification is a major challenge that IT service providers face today. Service providers need to know about the potential risks for a given new opportunity ahead of contract signing to (1) make educated decisions about whether to undertake the IT operations of a potential client, (2) be proactive about mitigation planning if they are willing to take on a risky contract, and (3) price the contracts accordingly to account for risks that cannot be mitigated.

Another reason for poor financial performance in the early stages of a contract is often the lack of a quantitative approach to objectively evaluate risk impact and prioritize risk management tasks. Existing risk management processes have limitations. Service providers often need to decide on a contract with limited access to the client's IT environment without thoroughly understanding potential risks. Although many risks can be identified at engagement, there are frequently too few resources to manage them all. Even if risks are known ahead of time, it may not be possible to quantify their impact, which makes it difficult to put price contingencies in contracts should the service provider decide to take on a risky contract. Previous research on impact quantification has mostly focused on high level IT risks and associated costs rather than quantifying contract risks at a fine level of granularity.

### BRIEF SUMMARY

According to an aspect of the invention, there is provided a method for predicting and quantifying risk in information technology (IT) service contracts that includes comparing features of a new IT service contract with similar features from one or more previous IT service contracts selected from a plurality of previous IT service contracts to calculate a similarity value between each pair of said new IT service contract and one of the one or more previous IT service contracts, aggregating the similarity values, and using the aggregated similarity values with a prediction model to predict contract profitability and risk factors affecting the new IT service contract and to quantify an impact of each predicted risk factor on an expected gross profit margin. The previous contracts include existing contracts and historical contracts no longer in force. The prediction model recommends mitigating actions for each predicted risk factor.

### BRIEF DESCRIPTION OF THE SEVERAL VIEWS OF THE DRAWINGS

FIG. 1 depicts an overview of a financial risk analytics tool according to an embodiment of the disclosure.

FIG. 2 illustrates how contract similarity can be used to provide predictions for a new contract according to an embodiment of the disclosure.

FIG. 3 shows pseudo-code for a method for determining contract similarity, according to an embodiment of the present disclosure.

FIG. 4 illustrates a method for measuring contract profitability, according to an embodiment of the present disclosure.

FIG. 5 shows an extended model according to an embodiment of the disclosure, that treats the result of the regression model as an indicator.

FIG. 6 illustrates a method of predicting and quantifying risk according to an embodiment of the disclosure.

FIG. 7 is a screenshot of an exemplary FRA tool implementation according to an embodiment of the disclosure.

FIG. 8 is a screenshot showing more information about a particular risk selected from a top 15 list shown in FIG. 7, according to an embodiment of the disclosure.

FIG. 9 is a block diagram of an exemplary computer system for implementing a method for using risk prediction models to predict potential contract risks and their impact according to an embodiment of the disclosure.

### DETAILED DESCRIPTION

Exemplary embodiments of the invention as described herein generally include systems and methods for using risk prediction models to predict potential contract profitability, relevant contract risks and their impact. Accordingly, while embodiments of the invention are susceptible to various modifications and alternative forms, specific embodiments thereof are shown by way of example in the drawings and will herein be described in detail. It should be understood, however, that there is no intent to limit embodiments of the invention to the particular forms disclosed, but on the contrary, embodiments of the invention cover all modifications, equivalents, and alternatives falling within the spirit and scope of the disclosure.

A financial risk analytics according to embodiments of the present disclosure can enable quality analysts and risk managers to learn about and proactively manage potential contract risks before they materialize, while also providing guidance to contract pricers to include the necessary cost contingencies into pricing considerations, in case of a high risk contract. Financial risk analytics (FRA) includes predictive models built from historical contract data and observed risks, and provides insights on contract profitability as well as potential risks and their impact for a given new opportunity ahead of contract signing. FRA, thus, enables service providers to make educated decisions about whether to undertake the IT operations of a potential client, or proactively mitigate risks for service providers that are willing to take on a risky contract. Finally, service providers can use FRA insights to adjust contract prices according to the predicted risk impact, if risk mitigation is not feasible.

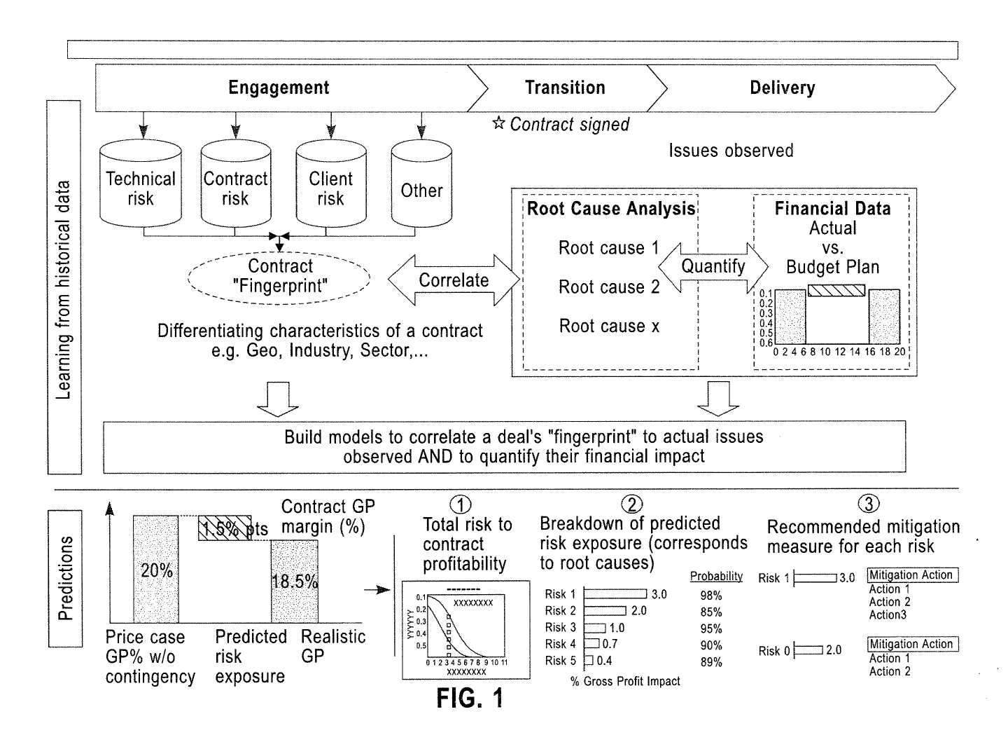

A financial risk analytics (FRA) tool according to an embodiment of the disclosure can provide predictive models to shed light into potential contract risks and quantify their impact, while also recommending mitigation actions for proactive risk management. FIG. 1 depicts an overview of a financial risk analytics tool according to an embodiment of the disclosure. Prior to the engagement phase, a predictive model according to an embodiment of the disclosure needs at least three types of training data from historical contracts:

(1) Various risk assessments from historical contracts, such as technical, contract and client risk assessments, as well as differentiating characteristics of contracts, which altogether form a contract fingerprint. Characteristics that differentiate contracts include, but are not limited to, geographic locations of IT service contract providers and clients, an industry of the client, total contract value, contract specifics, such as the type of transformation that will be performed on the client's IT environment, e.g., whether the IT service provider will take over the operation of the client's datacenters or not, etc, and the cost case. Each feature in a contract fingerprint can be converted into a numerical or categorical value. For example, risk managers or quality assurance specialists can answer risk assessment questions using one of N/A, Low, Medium, High and Exceptional, which can be mapped to numeric values as N/A=0, Low=1, Medium=2, High=3, Exceptional=4, for use in calculations.

(2) Risk root causes observed from contract reviews for these historical contracts during transition or delivery. Examples of root causes include, but are not limited to, inaccurate staffing plans, inadequate transition plans, committed service delivery time not achievable, client responsibility not fulfilled, etc.

(3) The financial performance of the historical contracts, namely the actual performance compared to the original plan.

Both the root cause analysis data and the financial data can be quantified, and this quantified data is correlated with the contract fingerprint. Trained with the above data, a predictive model according to an embodiment of the disclosure can, for a new contract, based on its fingerprint, (1) calculate probabilities of attaining a range of predicted GP percentages, from which the model can predict whether a new contract is likely to meet the profit target, and if not, miss by how much; (2) breakdown potential risks along with their likelihood of happening and financial impact; and (3) recommend mitigation actions for proactive management of the predicted risks. In the example shown in FIG. 1, a predictive model according to an embodiment of the disclosure can provide a price case gross profit (GP) percentage without contingency of 20%, a predicted risk exposure of 1.5%, and a realistic GP margin of 18.5%.

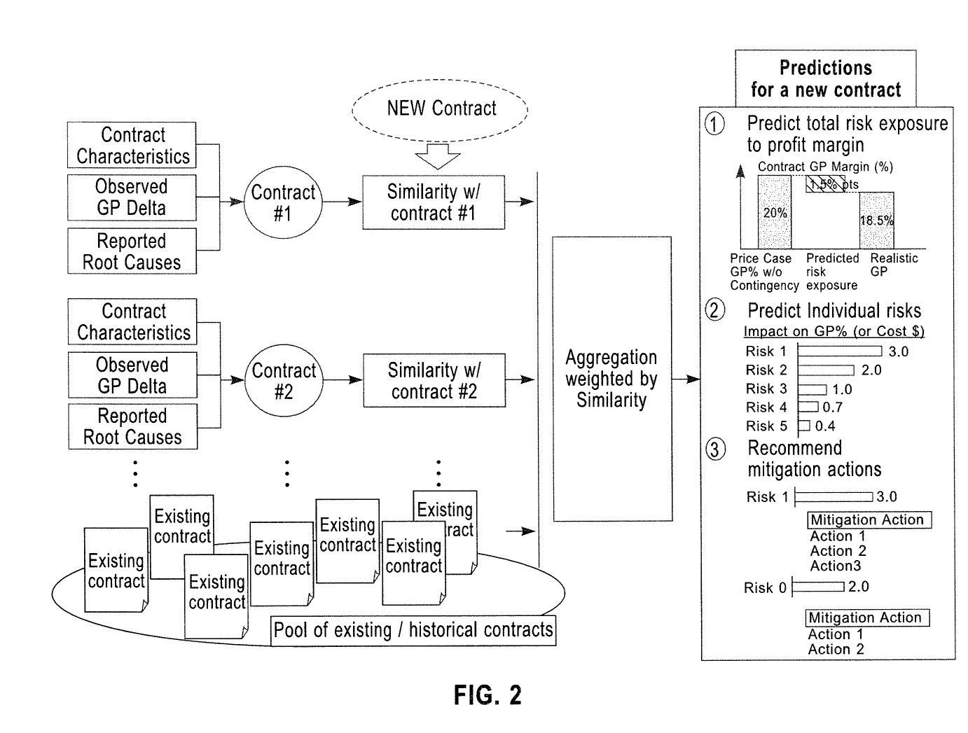

An FRA's predictive model according to an embodiment of the disclosure is based on a similarity measure between contracts. FIG. 2 illustrates how contract similarity can be used to provide predictions for a new contract. That is, a prediction for a given new contract is based on a measurement of similarity between the new contract and a set of historical contracts, based on their fingerprints. Referring to FIG. 2, for each contract taken from a pool of existing/historical contracts, the contract characteristics, observed GP deltas (the difference between the predicted and actual GP percentage), and reported root causes will be compared with corresponding features of the new contract, and the results of these comparisons will be aggregated, weighted by the similarity of each existing contract to the new contract, to yield a set of predictions. The details of contract similarity measure will be provided below. With this definition, an FRA predictive model according to an embodiment of the disclosure can then provide (1) a contract profitability prediction; (2) a risk prediction; and (3) recommended mitigation actions for each predicted risk. In the example shown on the right side of FIG. 2, an FRA predictive model can predict the total risk exposure to the GP margin, predict the impact in percentages of individual risks on the GP margin, and for each risk, list recommended mitigation actions.

### Contract Similarity

In a prediction model definition according to an embodiment of the disclosure, two contracts are similar if they have similar contract fingerprints. A historical contract data set according to an embodiment of the disclosure includes more than 300 features in each contract fingerprint, although not all features are equally important or useful for risk predictions. To ensure that the more significant features provide a greater contribution to the similarity measure, higher weights are assigned to them. Since a goal of determining contract similarity is to predict risks, weights are assigned to features based on their correlation with the actual similarity between a pair of contracts, in terms of their reported risks.

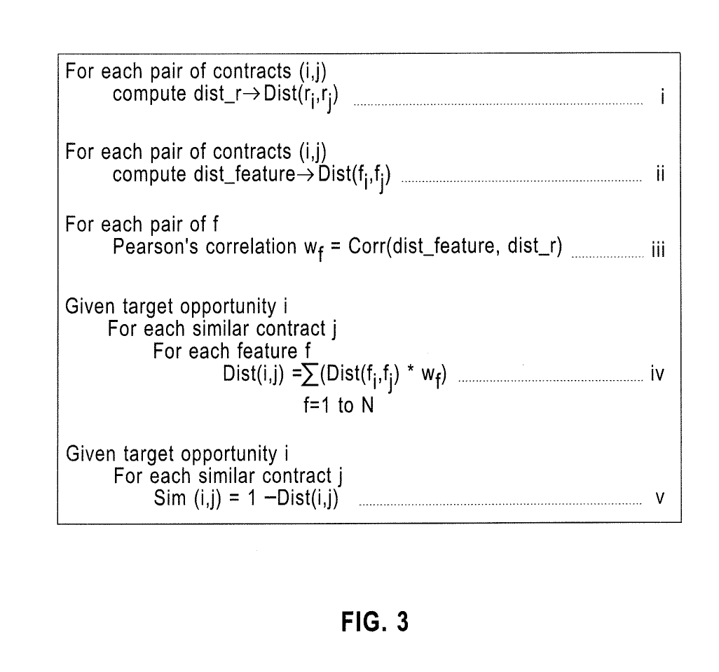

FIG. 3 presents pseudo-code for a method for determining contract similarity, according to an embodiment of the present disclosure. To calculate a weight w_{f} for each feature f, one computes a Pearson's Correlation between risk distances and feature distances. The stronger the correlation, the higher weight will be assigned to feature f.

Referring to FIG. 3, risk (root cause) distances for all contracts are computed at step (i) by comparing the risks for each pair of contracts and calculating the difference between these risks, denoted by dist_r. According to an embodiment of the invention, a measurement of risk distances can be calculated between any pair of known contracts based on the overlap of their risks. In essence, if contract 1 has N risks and contract 2 has M risks, and they share X risks, then their risk distance is x/(N+M−x), a value between 0 and 1. Similarly, feature distances are calculated for all historical contracts in step (ii), denoted by dist_feature, by comparing the features for each pair of contracts. According to an embodiment of the invention, feature distances can be calculated between any pair of known contracts by taking a difference of their features. In other words, given contract 1 feature 1 (c₁f₁) and contract 2 feature 1 (c₂f₁) (i.e., the same feature for both contracts), then (c₁f₁−c₂f₂)/(maxf₁Value−minfᵢValue) yields a normalized value between 0 and 1, indicting a feature distance of contracts 1 and 2.

The Pearson's Correlation coefficient is calculated based on the values of (i) and (ii) at step (iii), which, after normalization, is used as a weight (w_{f}) for each feature. Given a target opportunity i, based on the vector of weighted features, i.e., the weighted fingerprint, the Euclidian distance, denoted Disk(i,j), between the target opportunity and each historical contract is calculated in step (iv) by summing over all features the feature distance between each pair of contracts being compared weighted by the Pearson's Correlation coefficient for the feature. The final step is to calculate contract similarity Sim(i,j) between the target opportunity i and each historical contract j from the Euclidian distance Dist(i,j) as shown in step (v).

### Predicting GP Delta

According to an embodiment of the present disclosure, contract profitability is measured using the change in the gross profit margin, referred to as a GP delta, which is determined by subtracting from the planned GP % the actually observed GP % for a given contract:

GP Delta=GP Plan−GP Actual.

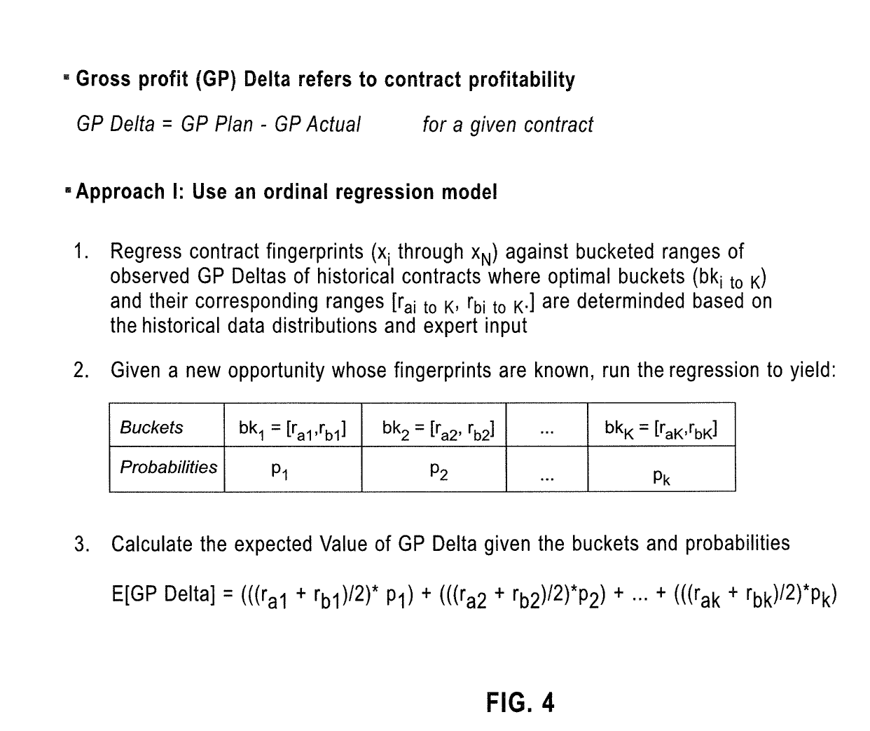

FIG. 4 illustrates a method for measuring contract profitability, according to an embodiment of the present disclosure. Referring to FIG. 4, an approach according to an embodiment of the disclosure for predicting contract profitability builds an ordinal regression model at step 1 by regressing fingerprints of the historical contracts (x₁ through x_{N}) as the independent variables against several pre-defined buckets of observed GP delta ranges from historical contracts as the dependent variables, where the optimal range (r_{a1 to K}, r_{b1 to K}) of buckets (bk_{1 to K}) are determined based on the historical distributions and expert input.

At step 2, once a regression model according to an embodiment of the disclosure is in place, given a new opportunity and its fingerprint, the regression model yields a set of (bucket, probability) pairs that define the probability of the GP delta prediction falling into a specific bucket. For example, a prediction could yield an 85% probability that the GP delta will fall into bucket [0, 5] which would mean a positive GP delta, indicating that the predicted profit margin is 0 to 5% higher than the plan. Finally, at step 3, an expected value for GP delta is calculated by multiplying the mid-points of the ranges, assuming a uniform distribution within the range, by the respective probabilities (pᵢ) of the GP delta falling in that bucket, and summing the products:

$$E [ GP Delta ] = {\sum }_{i = 1}^{K} \frac{1}{2} {p}_{i} \times ( {r}_{ai} + {r}_{bi} ) .$$

While a regression model according to an embodiment of the disclosure as shown in FIG. 4 provides a good prediction on GP Delta range when tested against historical contract data, other embodiments of the disclosure further incorporate contract similarity with a regression model according to an embodiment of the disclosure to provide a more fine-grained prediction on GP Delta.

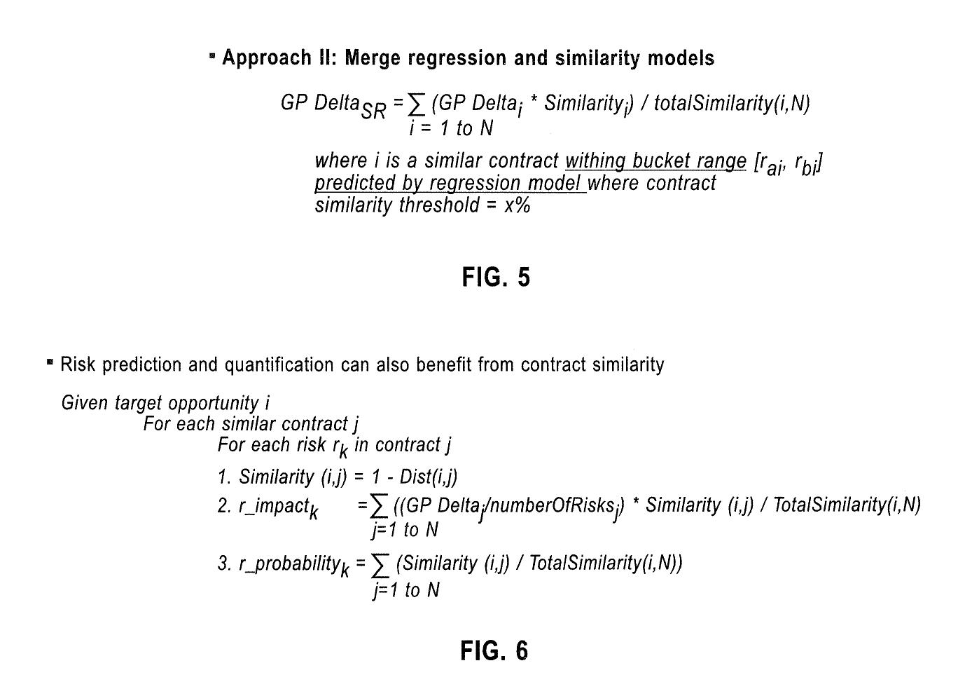

In an extended model according to an embodiment of the disclosure, illustrated in FIG. 5, the result of the regression model is treated as a direction indicator. For a given new contract, the aforementioned regression model is used to determine which range the GP delta is most likely to be in, e.g., [0, 5] with 85% probability.

Next, a GP delta of the new opportunity, GP Delta_{SR}, is predicted by taking a weighted average of the GP deltas of the similar historical contracts, whose GP deltas fall into that particular (say [0, 5]) bucket, where the weights refer to contract similarity, which is normalized to have values in the range [0, 1], as shown in FIG. 5:

$$GP {Delta}_{SR} = \frac{{\sum }_{i = 1}^{N} GP {Delta}_{i} \times {Similarity}_{i}}{totalSimilarity ( 1 , N )} ,$$

where totalSimilarity(1,N) is a sum of the Similarity's for each i, where i refers to a similar contract within the bucket range [rₐᵢ,r_{bi}] predicted by a regression model according to an embodiment of the present disclosure where a contract similarity threshold=x %.

### Risk Prediction and Quantification

For a service provider, knowing that a given opportunity is likely to become unprofitable is often not enough. Service providers also need to know what the potential risks are as well as how to quantify these potential risks to be able to mitigate them before they materialize.

Risk prediction and quantification can also benefit from a contract similarity determination according to an embodiment of the disclosure, as shown in FIGS. 2-3. A method of predicting and quantifying risk according to an embodiment of the disclosure is shown in FIG. 6. Given a target opportunity i, a set of similar contracts j are determined along with a degree of similarity Similarity(i,j)=1−Dist(i,j) [0 through 1], as shown in step 1. The Similarity(i,j) can be determined using a method such as that shown in FIG. 3.

For each reported risk (or root cause) of a historical similar contract, the potential impact can be calculated by dividing the GP Delta of this similar contract by the number of risks observed for this similar contract. Note that this is an approximation due to a lack of more accurate impact assignment data at the time of building the model, and can be improved if a risk management process according to an embodiment of the disclosure assigns certain impact values to each reported risk. A weighted average of all calculated impacts for this particular risk observed across all similar contracts is calculated such that the weight is determined by the degree of contract similarity (step 2):

$${r\_impact}_{k} = \frac{{\sum }_{j = 1}^{N} ( ( GP {Delta}_{j} / {numberOfRisks}_{j} ) \times Similarity ( i , j ) )}{TotalSimilarity ( 1 , N )} .$$

The probability of risk k for target opportunity i is calculated at step 3 by taking a weighted average of the number of occurrences across all similar contracts such that the weight is, again, determined by the degree of contract similarity:

$${r\_probability}_{k} = \frac{{\sum }_{j = 1}^{N} Similarity ( i , j )}{TotalSimilarity ( 1 , N )} .$$

### FRA Tool

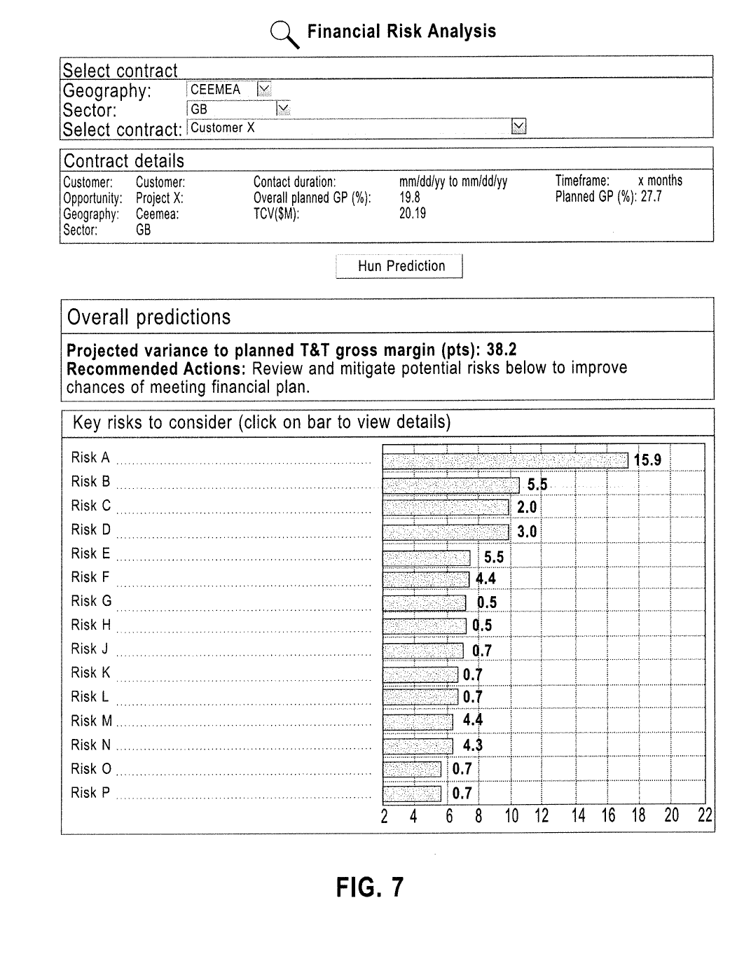

FIG. 7 shows a screenshot of an exemplary FRA tool implementation according to an embodiment of the disclosure. The following data from historic contracts is used to train a prediction model according to an embodiment of the invention: Client Risk Assessments; Technical Risk Assessments; Contract Risk Assessments; Reported Risks (Root Causes); and Financials. An FRA tool according to an embodiment of the disclosure can provide predictive analytics using regression and similarity, and for a new client, can predict contract profitability and potential key risks that are likely to materialize.

To use a tool according to an embodiment of the invention, a user first selects a Geography and a Sector to narrow down the set of available opportunities to analyze ahead of contract signing, and then selects a contract opportunity of interest. Once the opportunity of interest is selected, e.g., Customer X, contract details are shown, and the user can press the Run Prediction button to display the results of an FRA according to an embodiment of the invention.

An FRA tool according to an embodiment of the disclosure can predict the contract profitability (GP Delta) as well as a predetermined number of top potential risks for the target opportunity. For example, for Customer X, FIG. 7 shows that FRA predicts a GP Delta of −38.2 points, indicating a 38.2% less profitability than the plan, and the top 15 potential risks. For each predicted risk, FRA also displays a probability, represented by the horizontal bar on the right side of the figure. For example, risk D has an 8% probability of happening for the selected target opportunity (Customer X). The user can click on the bar to display further risk details. Customer names, dates and particular risk details in FIG. 7 have been anonymized for confidentiality reasons.

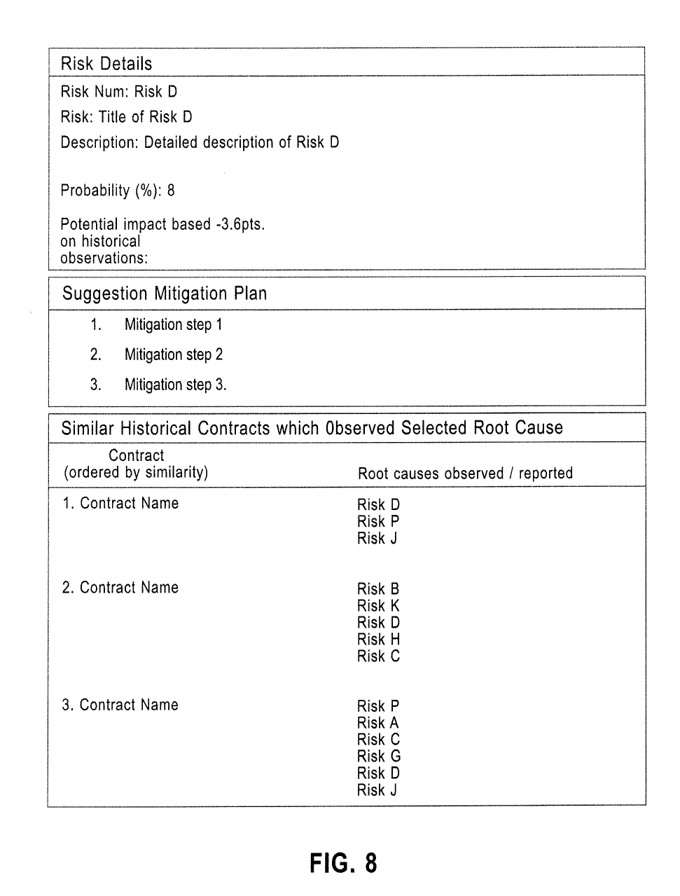

Selecting a particular risk from the top 15 list reveals more information about that risk, as shown in the screenshot of FIG. 8. The additional risk details include a risk description, a probability of occurrence and its impact.

For example, the screenshot of FIG. 8 reveals additional information for Risk D after the user has selected it through the interface shown FIG. 7. In addition to more detailed description of Risk D, FRA also shows the probability (8%) and the potential impact (−3.6 points) of that risk for the target opportunity.

Another important step in risk management is risk mitigation. For each predicted risk, FRA can show a set of mitigation steps the user can take to proactively manage that risk before it materializes.

Finally, the user can be presented with a set of similar historical contracts along with their observed risks to enable a more detailed investigation of potential risks, if needed.

Detailed risk definitions, associated mitigation steps and similar contract names In FIG. 8 have been anonymized for confidentiality reasons.

### System Implementations

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

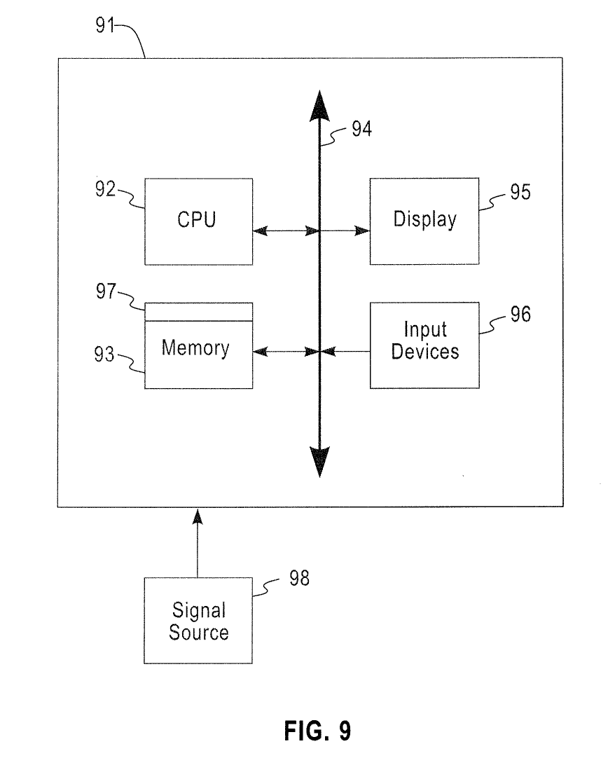

FIG. 9 is a block diagram of an exemplary computer system for implementing a method for using risk prediction models to predict potential contract risks and their impact according to an embodiment of the invention. Referring now to FIG. 9, a computer system 91 for implementing the present invention can comprise, inter alia, a central processing unit (CPU) 92, a memory 93 and an input/output (I/O) interface 94.

The computer system 91 is generally coupled through the I/O interface 94 to a display 95 and various input devices 96 such as a mouse and a keyboard. The support circuits can include circuits such as cache, power supplies, clock circuits, and a communication bus. The memory 93 can include random access memory (RAM), read only memory (ROM), disk drive, tape drive, etc., or a combinations thereof. The present invention can be implemented as a routine 97 that is stored in memory 93 and executed by the CPU 92 to process the signal from the signal source 118. As such, the computer system 111 is a general purpose computer system that becomes a specific purpose computer system when executing the routine 117 of the present invention.

The computer system 91 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been described in detail with reference to exemplary embodiments, those skilled in the art will appreciate that various modifications and substitutions can be made thereto without departing from the spirit and scope of the invention as set forth in the appended claims.

1. A computer-implemented method for predicting and quantifying risk in information technology (IT) service contracts, the method executed by the computer comprising the steps of:
comparing features of a new IT service contract with similar features from one or more previous IT service contracts selected from a plurality of previous IT service contracts to calculate a similarity value between each pair of said new IT service contract and one of said one or more previous IT service contracts;
aggregating said similarity values; and
using said aggregated similarity values with a prediction model to predict contract profitability and risk factors affecting said new IT service contract and to quantify an impact of each predicted risk factor on an expected gross profit margin.

2. The method of claim 1, wherein said previous contracts include existing contracts and historical contracts no longer in force.

3. The method of claim 1, wherein said prediction model recommends mitigating actions for each predicted risk factor.

4. The method of claim 3, wherein said prediction model is trained using risk assessment data from previous contracts and characteristics that differentiate contracts, risks observed for each previous contract, and the actual financial performance compared with the projected financial performance of each previous contract.

5. The method of claim 4, wherein the risk assessment data includes technical risk assessment data, contract risk assessment data, and client risk assessment data.

6. The method of claim 4, wherein the characteristics that differentiate contracts comprises geographic locations of IT service contract providers and clients, an industry of the client, total contract value, contract specifics, and a cost case.

7. The method of claim 6, wherein contract specifics includes the type of transformation that will be performed on a client's IT environment.

8. The method of claim 1, wherein calculating the similarity value between each pair of contracts comprises:
comparing risks for each pair of contracts in the plurality of previous IT service contracts and calculating a difference between these risks to calculate a risk distance for each pair of contracts;
comparing features for each pair of contracts in the plurality of previous IT service contracts and calculating a difference between these features to calculate a feature distance for each pair of contracts;
calculating a Pearson's correlation coefficient for each feature from the risk distance and the feature distance;
for each feature in said new contract and one or more previous IT service contracts, calculating a Euclidian distance between the new IT service contract and each of the one or more previous IT service contracts by summing over all features the feature distance between each pair of contracts being compared weighted by the Pearson's Correlation coefficient for the feature; and
calculating the similarity value between the new IT service contract and each of the one or more previous IT service contracts from said Euclidean distance between the new IT service contract and each of the one or more previous IT service contracts.

9. (canceled)

10. The method of claim 1, wherein calculating the expected gross profit margin comprises:
regressing each of the plurality of previous IT service contracts against bucketed ranges of observed gross profit margin changes;
regressing said new IT service contract to determine a probability of an expected gross profit margin change for each bucket; and
summing the probabilities for each bucket weighted by a mid-point value for each bucket to obtain an expected value of a gross profit margin change for said new IT service contract.

11. The method of claim 10, further comprising refining said gross profit margin change expected value for said new IT service contract by calculating a weighted average of gross profit margin changes for similar previous IT service contracts whose gross profit margin changes fall into a same bucket as the gross profit margin change expected value for said new IT service contract, wherein each weight is the similarity value of the new IT service contract and one of the similar previous IT service contracts divided by a total similarity between the new IT service contract and the similar previous IT service contracts, wherein the total similarity is a sum of the similarities between the new IT service contract and each of the similar previous IT service contracts.

12. The method of claim 10, further comprising calculating an impact of each risk factor by summing a product of a gross profit margin change for each of the one or more previous IT service contracts with the similarity value between the new IT service contract and each of said one or more previous IT service contracts, divided by a total number of risks for each of said one or more previous IT service contracts, and dividing by a total similarity between the new IT service contract and the one or more previous IT service contracts, wherein the total similarity is a sum of the similarities between the new IT service contract and each of the one or more previous IT service contracts.
